(19) United States
(12) Patent Application Publication
(10) Pub. No.: US 2015/0108736 A1
(43) Pub. Date: Apr. 23, 2015

(54) Trailer autoconnect system

(71) Applicant: Joseph P. Jamieson, Sanger, TX (US)

(72) Inventor: Joseph P. Jamieson, Sanger, TX (US)

(21) Appl. No.: 13/998,266

(22) Filed: Oct. 17, 2013

(51) Int. Cl. B60D 1/38; B60D 1/36

(52) U.S. Cl. CPC B60D 1/38; B60D 1/36
USPC 280/477

(57) ABSTRACT

The trailer autoconnect system is an apparatus for bringing into close juxtaposition a trailer and a trailer hitch attached to a tow vehicle. Specifically, an electric or manual winch is attached to the trailer to be attached to the hitch of the towing vehicles. The cable of the winch extends through a guide bracket and through a series of pulleys so that the end of the winch cable is connected to the tow hitch of the tow vehicle. The winch is activated electrically or manually by a crank or lever and the trailer is pulled directly to the tow hitch of the tow vehicle. A laser emitter attached to the coupling mechanism of the trailer emits a beam of light which illuminates the hitch receiver of the towing vehicle enabling the operator to raise or lower the coupling mechanism of the trailer to bring the coupling mechanism of the trailer into proper alignment with the hitch receiver. When the two coupling mechanisms are located in place so that the trailer can be coupled to the tow hitch of the tow vehicle, the trailer is lowered onto the receptacle of the tow hitch of the tow vehicle and the union of the trailer and tow vehicle is made secure.

### CROSS-REFERENCE TO RELATED APPLICATIONS

This application claims benefit of and priority to U.S. Provisional Patent Application No. 61/795.495 which was filed on Oct. 18, 2012 and is incorporated herein by reference as if fully set forth.

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

None

### REFERENCE TO A SEQUENCE LISTING

Not applicable.

### BACKGROUND OF THE INVENTION

1. Field of the Invention

The field of the invention disclosed herein is a trailer connection and towing system and more particularly an apparatus and method for moving the trailer so that the coupling mechanism is automatically moved to the hitch mechanism of the towing vehicle via the trailer's winch cable. The trailer coupling mechanism is drawn directly to the hitch mechanism of the towing vehicle regardless of the alignment with the hitch mechanism of the towing vehicle. The trailer tongue is positioned by electrical or mechanical means so that the coupling mechanism of the trailer is connected to the hitch mechanism attached to the receiver of the towing vehicle.

2. Description of the Related Art

The ability to attach a trailer loaded with everything from farm animals, equipment and recreational vehicles has enhanced the ability to transport items down the streets and highways when the trailer is coupled to a towing vehicle such as a car or pickup truck. When the trailer is not needed, the trailer can be disengaged from the towing vehicle, freeing the towing vehicle for other tasks such as shopping, taking the children to school or athletic events. The trailer can be parked until needed again.

One of the problems associated with transporting items in a trailer is attaching the trailer to the towing vehicle. Various coupling systems have been developed to physically connect the trailer to the towing vehicle. Those coupling systems usually consist of a ball or receiver which is firmly attached to the towing vehicle. The hitch receiver may have attached a ball onto witch the coupling device on the trailer attaches. Once the trailer is coupled to the receiver ball it is secured by various means so that the trailer will not become “unhitched” from the towing vehicle. As a safety measure, chains extending from the trailer are attached to the hitch receiver mechanism on the towing vehicle so that if the trailer coupling becomes “unhitched” from the ball on the towing vehicle receiver, the chains will keep the trailer in communication with the towing vehicle so that the towing vehicle remains in control of the trailer.

In large tractor trailer rigs, the receiver consists of a large metal plate very securely attached to the chassis of the tractor truck at the rear of the truck. The receiver has a groove into which the coupling device is inserted. The driver backs the tractor truck toward the trailer and skillfully inserts the coupling mechanism of the trailer into the groove on the receiver of the tractor truck. Once this is accomplished the trailer hitch is secured and the trailer can rotate around the receiver to facilitate turning the truck.

In smaller vehicles such as cars and pickup trucks, the towing vehicle must be maneuvered into place so that the hitch receiver on the towing vehicle is in alignment with the coupling mechanism on the trailer. In this manner, the towing vehicle may be connected to the trailer for transport. However, this process may be difficult especially for the inexperienced driver or lone driver of the towing vehicle. Several methods have been developed to accomplish connection of the towing vehicle to the trailer.

The simplest method is for the driver of the towing vehicle to back the towing vehicle in reverse using the rear view and side mirrors to assist the driver in backing the towing vehicle toward the trailer. The process is often performed with the help of an observer located at the rear of the towing vehicle who gives voice and/or hand signals to the driver to guide the driver to the trailer coupling device. This method often results in imperfect alignment of the hitch receiver on the towing vehicle and the coupling device on the trailer. This imperfect alignment of the hitch receiver on the towing vehicle and the coupling device on the trailer requires repeated attempts to bring the hitch receiver and coupling device into alignment.

Another method used to bring the hitch receiver of the towing vehicle into alignment with the coupling mechanism of the trailer employs a small video camera located on the rear bumper of the towing vehicle. The video image of the rear of the towing vehicle captured by the video camera is displayed on a small video screen located in the driver's compartment of the towing vehicle so that the driver may view his vehicle's progress toward alignment with the trailer. This too may result in imperfect alignment of the towing vehicle's hitch receiver and the coupling mechanism of the trailer.

Another method not particularly favored by those who have attempted it, is to collect one or more individuals and pull the trailer toward the towing vehicle and physically bring the coupling device into alignment with the hitch receiver of the towing vehicle. This method may be impossible depending on the weight of the trailer. Even in the situation where mirrors or video cameras are used to enable the driver to maneuver the towing vehicle so that the hitch receiver of the towing vehicle may be attached to the coupling mechanism of the trailer, there may be a gap between the hitch receiver and the coupling mechanism of the trailer which must be bridged before the trailer can be moved by the towing vehicle. Again, overcoming this gap may be difficult or impossible given the weight of the trailer and other factors. What is needed in the art is an apparatus and method which can easily and accurately guide the coupling mechanism on the trailer to the hitch receiver on the towing vehicle and bring the two coupling mechanisms together.

### BRIEF SUMMARY OF THE INVENTION

The invention disclosed herein is an apparatus and method which can easily and accurately guide the coupling mechanism of the trailer to the hitch receiver on the towing vehicle and bring the two coupling mechanism together. Specifically, a manual or electrical winch is attached to the trailer and the winch cable is attached at or near the hitch receiver on the towing system. The cable extending from the winch passes through a guide bracket and system of rollers. When the winch cable is connected at or near the hitch receiver on the towing vehicle, the winch is activated which pulls the trailer toward the towing device. The coupling mechanism on the trailer will automatically move directly to the hitch receiver on the towing vehicle. The coupling mechanism on the trailer is lowered or raised to the level of the coupling mechanism of the hitch receiver. The winch may be electrically operated or powered by hand crank. The trailer does not have to be located directly behind the towing vehicle. The trailer may be at an angle, either right or left from the center of the towing vehicle and still be moved to the hitch receiver of the towing vehicle for attachment. An optional laser emitter may be attached to the coupling mechanism of the trailer to guide the trailer to the correct elevation and alignment of the coupling mechanism with the hitch receiver on the towing vehicle. The trailer autoconnect system also incorporates a wheeled jack stand attached to the tongue of the trailer to facilitate movement of the trailer to the towing vehicle

### BRIEF DESCRIPTION OF THE SEVERAL VIEWS OF THE DRAWING

A better understanding of the invention disclosed herein may be had by examination of the following drawing/figures:

FIG. 1A is a side view of one of the embodiments of the invention disclosed herein.

FIG. 1B is a side view of one of the embodiments of the invention disclosed herein.

FIG. 2 is a side view showing the winch cable connection between the trailer and the towing vehicle.

FIG. 3 is a side view of the invention disclosed herein wherein the winch cable has pulled the trailer to the towing vehicle.

FIG. 4 is a top view of the invention disclosed herein showing the relationship of the winch to the winch cable.

FIG. 5 is a bottom view of the invention disclosed herein showing the relationship of the winch, pulleys, guide bracket and winch cable.

FIG. 6. is a side view of the invention disclosed herein showing the relationship of the winch, pulleys and winch cable.

FIG. 7 is a front view of the invention disclosed herein showing the front roller bracket

FIG. 8 is an expanded front view of the front roller bracket

FIG. 9 is a front view of the bottom pulley assembly

FIG. 10 is an expanded front view of the bottom pulley assembly

FIG. 11 is a side view of the winch cable receiver bracket attached to the receiver of the towing vehicle.

### DETAILED DESCRIPTION OF THE INVENTION

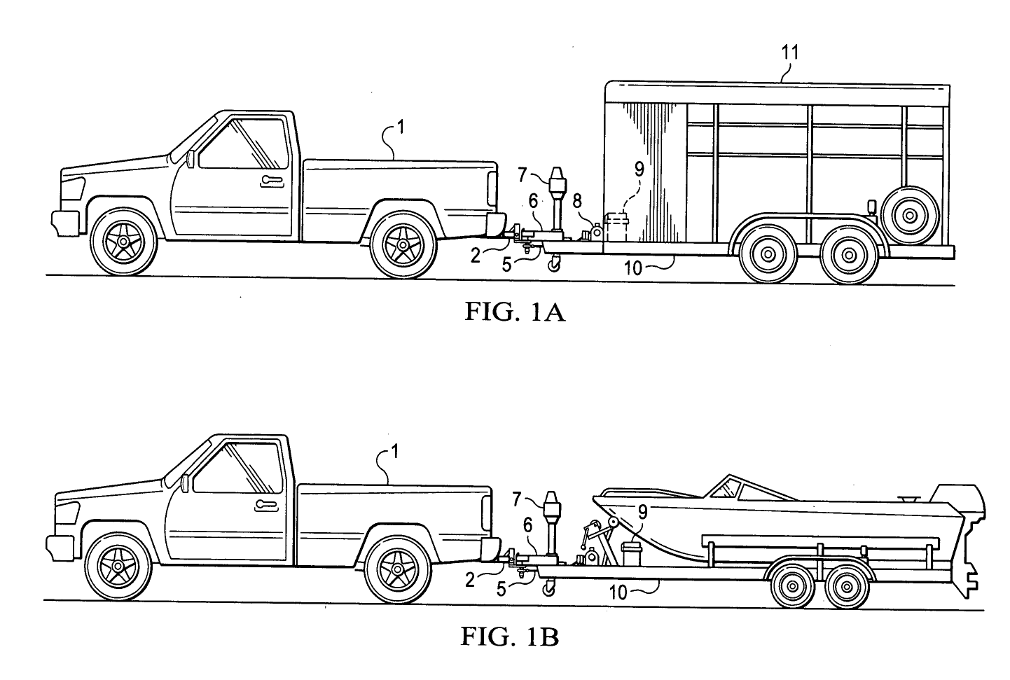

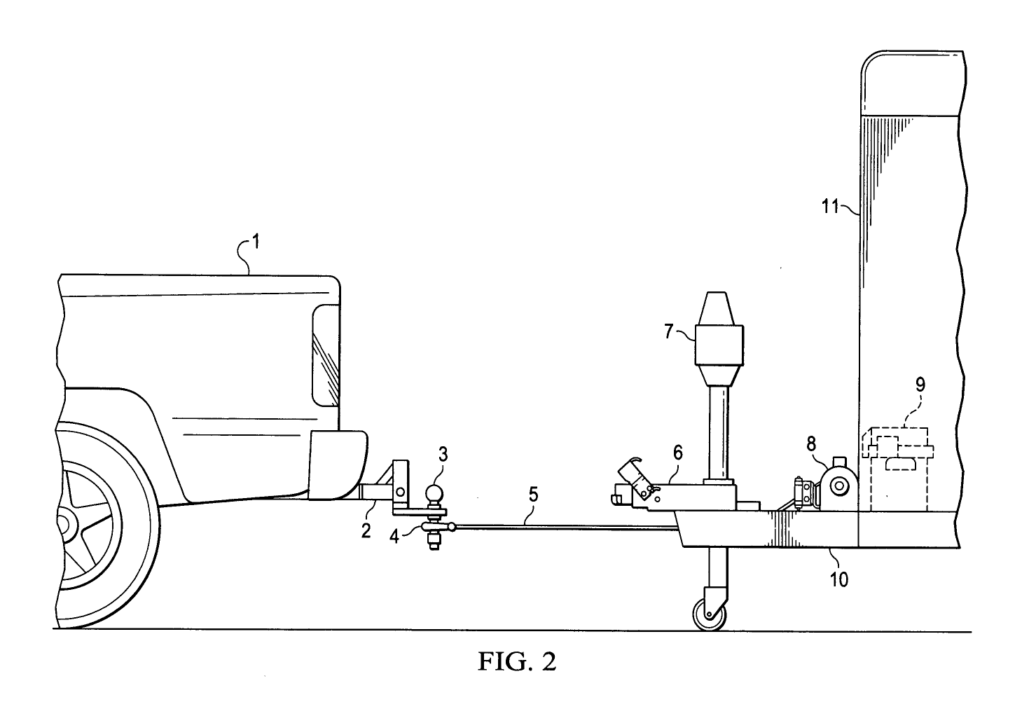

The problem solved by the invention disclosed herein is the difficulty in attaching a trailer to a towing vehicle operated by a lone individual especially when the towing vehicle and trailer are not in straight line alignment. The invention disclosed herein permits the operator to connect the trailer to the towing vehicle even though the line of travel between the trailer and towing vehicle is at an angle. As shown in FIGS. 1A and 1b, the invention disclosed herein may be used to move several types of trailers for connection to a towing vehicle. The embodiment in FIG. 1a shows a livestock trailer attached to the towing vehicle. The embodiment in FIG. 1b shows a boat trailer attached to the towing vehicle. Many other types of trailers are susceptible to being moved to the towing vehicle by the apparatus disclosed herein. Those would include, among others, an enclosed trailer, a flatbed trailer loaded with farm equipment, a stake trailer and a hay trailer for example. The towing vehicle shown in FIGS. 1a and 1b is a pickup truck but many different types of vehicles such as sport utility vehicles and automobiles could be used. The trailer 11 is attached to the towing vehicle 1 by attaching the coupling mechanism 6 attached to the frame 10 of the trailer 11 to the hitch receiver 2 located on the towing vehicle 1. The trailer 11 is moved into position aligned with the towing vehicle 1 by a winch 8 powered manually operated or powered by a battery 9. The winch cable 5 is attached to the hitch receiver 2 and the winch 8 reels in the winch cable 5 which moves the trailer 11 to the towing vehicle 1. A jack stand 7 with a pivotable wheel at the bottom of the jack stand 7 facilitates movement of the trailer 11 into alignment with the towing vehicle 1 for coupling. Additionally, the jack stand 7 enables the operator to raise or lower the coupling mechanism 6 into alignment with the hitch receiver 2.

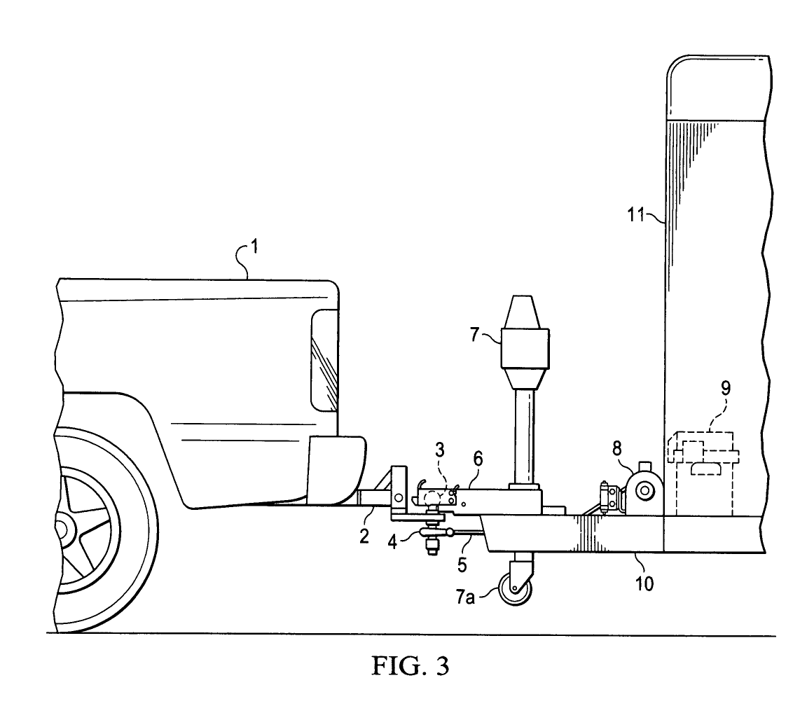

As shown in FIG. 2, the trailer 11 to be transported by the towing vehicle 1 is attached to the towing vehicle 1 by a winch cable 5 attached to the hitch fitting 3 on the receiver 2 of the towing vehicle 1. The winch cable 5 is attached to the receiver 2 by a hook 4 attached to the end of the winch cable 5 distal to the winch 8. The winch 8 is fastened to the frame 10 of the trailer 11. On activation of the winch 8 powered by a battery 9, the trailer 11 is pulled toward the towing vehicle 1 as the winch cable 5 is reeled in by the winch 8. Assisting the trailer's 11 movement to the towing vehicle 1 is a jack stand 7 which has a wheel located at the bottom of the jack stand 7 located at the front of the trailer 11. The jack stand 7 is raised or lowered so that the coupling mechanism 6 of the trailer 11 is elevated into coupling alignment with the hitch fitting 3 on the receiver 2 of the towing vehicle 1. When the coupling mechanism 6 of the trailer has been positioned directly above the hitch fitting 3 of the towing vehicle 1 the coupling mechanism 6 of the trailer 11 is lowered by the jack stand 7 onto the hitch fitting 3 to which the coupling mechanism 6 of the trailer 11 is securely fastened. In other embodiments the couple mechanism may be a device other than the standard ball hitch. In that event the trailer autoconnect system will align the coupling mechanism on the trailer with the coupling mechanism on the towing vehicle.

FIG. 3 shows the trailer 11 attached to the towing vehicle 1 by the trailer autoconnect system described herein. When the winch cable 5 is reeled into the winch 8, the trailer 11 is brought to the towing vehicle 1 so that the coupling mechanism 6 is aligned with hitch fitting 3 located on the hitch receiver 2 of the towing vehicle 1. The frame 10 of the trailer 11 is lowered by the jack stand 7 so that the coupling mechanism 6 of the trailer 11 is correctly seated on the hitch fitting 3 of the towing vehicle 1. After the coupling mechanism 6 of the trailer 11 is securely fastened to the hitch fitting 3 and the towing vehicle 1, the trailer 11 is ready to be transported to another location.

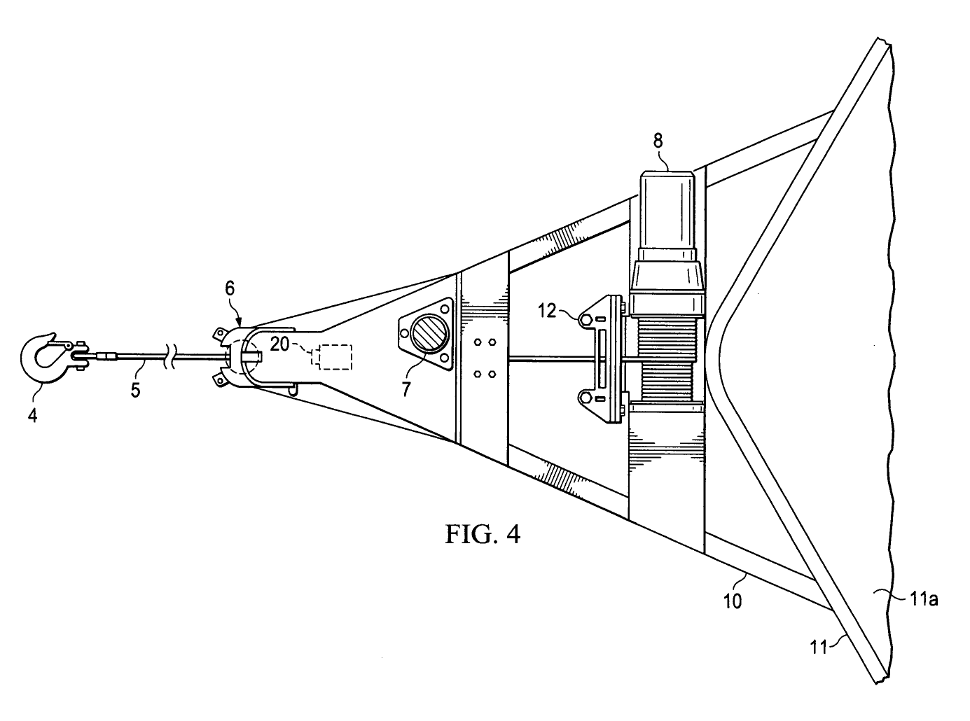

A top view of the apparatus disclosed herein is shown in FIG. 4. The winch 8 is fastened to the frame 10 directly in front of the cargo area 11a of the trailer 11. The winch cable 5 extends from the winch 8 on the underside of the trailer frame 10 through a fairlead 12, and coupling mechanism 6 and next to the jack 7. The hook 4 attached to the winch cable 5 attaches to the receiver so that the trailer 11 may be pulled by the winch 8 to the towing vehicle 1 for seating of the coupling mechanism 6 of the trailer 11 onto the hitch fitting of the towing vehicle. A laser emitter 20 attached to the underside of the coupling mechanism 6 shines a laser beam on the hitch fitting enabling the operator to determine the proper elevation of the coupling mechanism 6 for alignment of the coupling mechanism 6 with the hitch fitting.

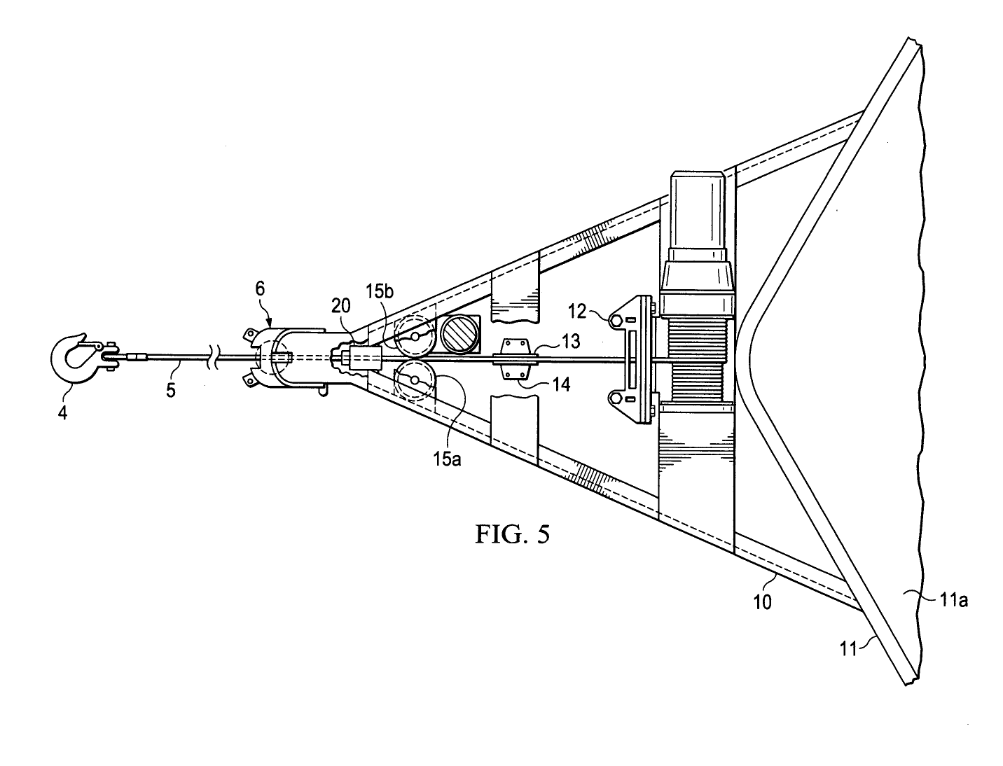

The underside of the trailer autoconnect system disclosed herein is shown in FIG. 5. The winch cable 5 exits the winch 8 through the fairlead 12 or cable guide bracket to a first roller 13 which brings the winch cable 5 into alignment with the winch roller 14. The winch cable 5 then passes by the jack 7 and through the opposing arcs formed by a front right roller 15b and a front left roller 15a. The winch cable 5 then extends under the coupling mechanism 6 of the trailer 11 where it can be connected to the hitch receiver of the towing vehicle by the hook 4 attached to the end of the winch cable 5 distal from the winch 8. It is necessary in this embodiment to attach the hook 4 to the winch cable 5 after the winch cable has traversed through the fairlead 12 from the winch 8 to the lower roller 14, passed by the jack stand 7, through the opposing arc made by the front right roller 15b and front left roller 15a and underneath the coupling mechanism 6 of the trailer 11. If the trailer 11 is not located directly behind the towing vehicle, the front right and left rollers 15a, 15b will allow the winch cable 5 to smoothly move at an angle either right or left, toward the towing vehicle. As the winch 8 reels in the winch cable 5, the trailer 11 will eventually line up to point directly at the hitch receiver located on the towing vehicle. The laser emitter 20 attached to the coupling mechanism 6 shines a beam of laser light at the hitch receiver enabling the operator to adjust the height of the coupling mechanism 6 to be in alignment with the hitch receiver. The laser emitter 20 may be mounted at or near the coupling mechanism 6 in such a manner as to direct the light emitted from the laser emitter 20 to the hitch receiver of the towing vehicle. The emitted laser beam will show that the front of the trailer 11 and the coupling 6 is being steered and elevated for proper connection to the hitch receiver. The color of the beam of laser light can be most any color but green and red light are preferable. The laser guidance system would assist the operator in guiding the trailer 11 to the hitch component of the truck in both daytime and nighttime conditions.

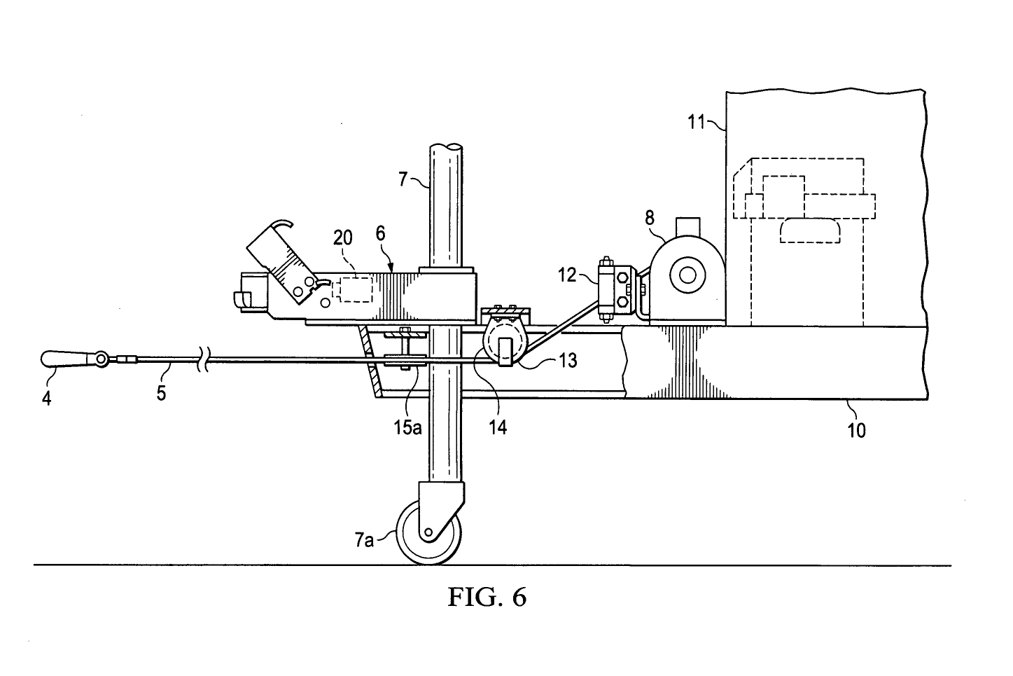

The winch cable 5 extends through the fairlead 12 attached to the winch 8 and is aligned with the winch cable roller 14 attached to the frame 10 of the trailer 11 by a bracket 13 as shown in FIG. 6. The winch cable 5 extends through the winch cable roller 14 to the opposing arc made by the front right and left rollers 15a, 15b.

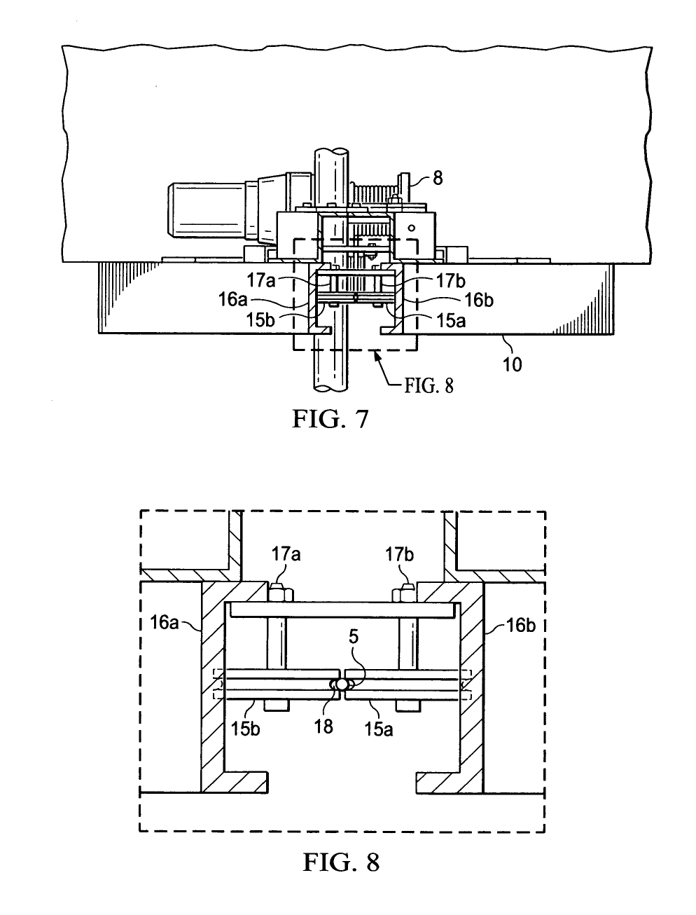

The arrangement and attachment of the front right and left rollers 15a, 15b are shown in FIGS. 7 and 8. The front right and left rollers 15a, 15b are attached to the frame 10 of the trailer by two U-shaped brackets 16a, 16b. The front right and left rollers 15a, 15b are attached to the U-shaped brackets 16a, 16b by bolts or other fasteners 17a, 17b. This arrangement creates the opposing arc 18 through which the winch cable 5 extends. If the trailer is located to the right of the towing vehicle, activation of the winch 8 to reel in the winch cable 5 will cause the winch cable 5 to roll along the front left roller 15a (from the view of the hitch receiver) and smoothly direct the front of the trailer toward the hitch receiver of the towing vehicle. If the trailer is located to the left of the towing vehicle, activation of the winch to reel in the winch cable 5 will cause the winch cable 5 to roll along the front right roller 15b (from the view of the hitch receiver) and smoothly direct the front of the trailer 11 toward the hitch receiver of the towing vehicle.

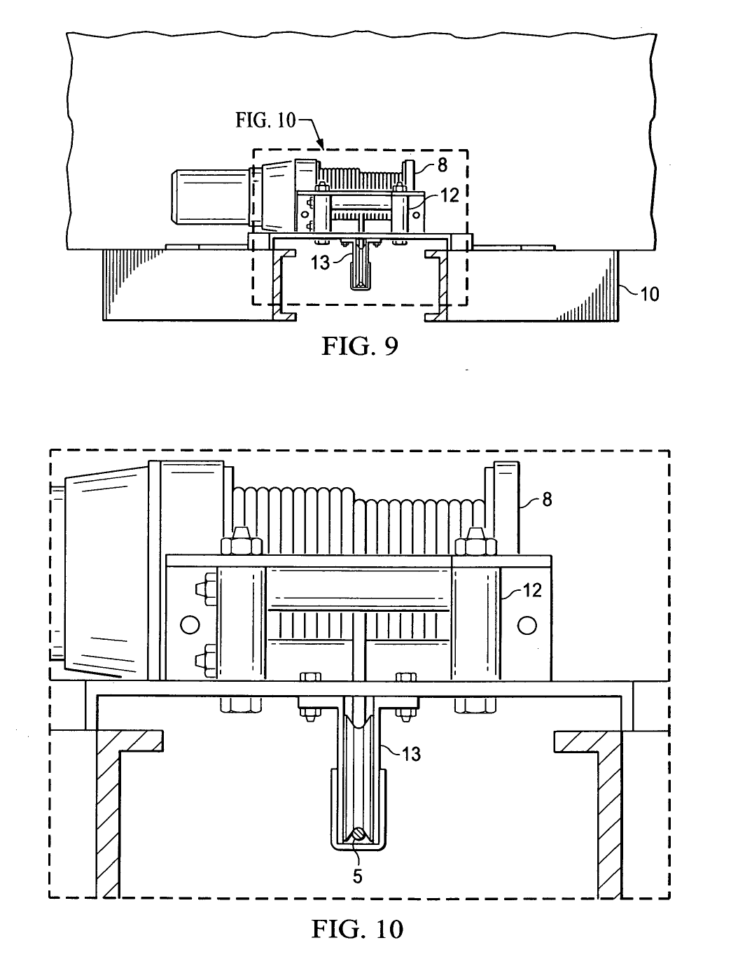

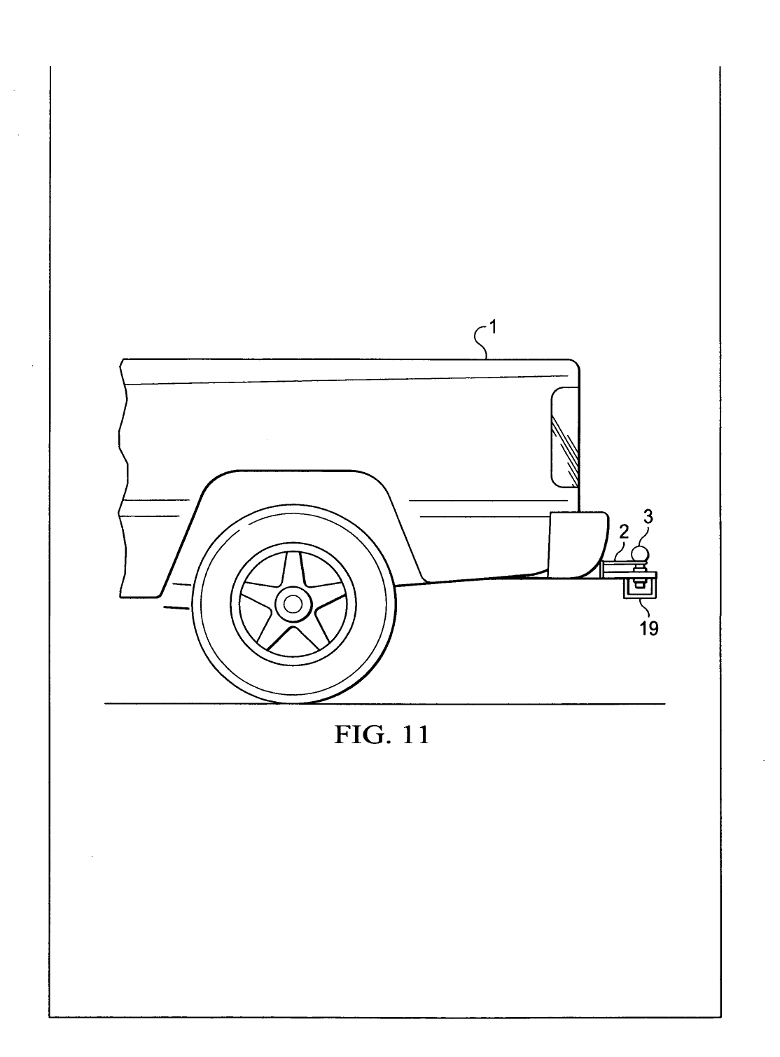

The winch cable 5 must travel under the frame 10 of the trailer in order to smoothly connect with the towing vehicle. However, the winch 8 is located on the topside of the frame 10 and therefore the winch cable 5 as it exits the winch 8 is also on the topside of the frame 10. In order to place the cable in proper alignment on the underside of the frame 10, the winch cable is passed through a roller 14 located on the underside of the frame 10 and connected to the frame 10 by a bracket 13 as shown in FIGS. 9 and 10. The winch cable 5 extends through the fairlead 12 or cable guide bracket from the winch 8 and extends forward toward the passage through the opposing arc created by the front right and left roller. The winch cable 5 is now in correct alignment for attachment to the hitch receiver of the towing vehicle. Since the winch cable 5 is in correct alignment for moving the trailer to the towing vehicle, there should be no obstruction or foul to hinder the winching operation.

The hook attached to the winch cable distal to the winch cannot attach to the hitch attached to the hitch receiver 2 of the towing vehicle 1 because in this embodiment of the invention disclosed herein, the coupling mechanism of the trailer must fit completely on to the hitch 3 of the towing vehicle 1. Attachment of the hook to the hitch 3 would block the complete fit of the coupling mechanism to the hitch 3. In this embodiment a hook attachment 19 is fastened to the bottom of the receiver 2 so that the hook may attach to the hook attachment 19 and be clear of the hitch 3 for complete seating of the coupling mechanism of the trailer.

The invention disclosed herein is susceptible to many embodiments. Different size winches may be attached to the trailer frame and thicker winch cables may be used for heavier loads. The winch may be manually operated eliminating the need for a battery. The apparatus may be used with many types of trailers loaded with many different objects and attached to many different types of hitch on many different types of towing vehicle. All of these other embodiments are incorporated into this disclosure and described by the claims appended hereto.

1. I claim an apparatus for connecting a trailer to the receiver hitch of a towing vehicle such that the coupling mechanism of the trailer is in alignment for connection to the hitch on the hitch receiver of the towing vehicle comprising:
a winch;
a winch cable which extends from said winch;
a winch cable guide bracket through which said winch cable extends;
a bottom roller through which said winch cable extends;
a front roller assembly which aligns a right front roller and left front roller through which the said winch cable traverses;
a hook on said winch cable distal to said winch;
a coupling mechanism aligned on the front of said trailer;
a laser emitter attached to said coupling mechanism and oriented to aim and project a laser beam toward said hitch receiver of said towing vehicle;
Whereby, upon attachment of said winch cable to said hitch receiver by said hook and activation of said winch, said winch cable is reeled into said winch causing said trailer to be pulled to said towing vehicle so that said coupling mechanism of said trailer is aligned to said hitch receiver of said towing vehicle in order that said coupling mechanism of said trailer can be securely fitted to said hitch receiver of said towing vehicle.
